(19) United States
(12) Patent Application Publication
(10) Pub. No.: US 2012/0034580 A1
(43) Pub. Date: Feb. 9, 2012

(54) SYSTEMS AND METHODS FOR FORMALIZED INTEGRATION OF CREATIVE MOVEMENT, RHYTHM AND EDUCATION

(76) Inventor: Marcia A. Daft, Chevy Chase, MD (US)

(21) Appl. No.: 13/277,537

(22) Filed: Oct. 20, 2011

Related U.S. Application Data
(63) Continuation of application No. 12/153,310, filed on May 16, 2008.

(51) Int. Cl. G09B 19/00

(52) U.S. Cl. 434/81

(57) ABSTRACT

Methods and systems are provided for teaching educational concepts through creative activities such as movement and vocalization. A systematic procedure is provided for lesson structures including (1) students experience a lesson through a first activity involving movement and/or rhythm, (2) students experience a lesson through a second activity involving movement and/or rhythm, (3) student observation and discussion, and (4) creative assessment. These steps may be performed in various orders to adapt to various educational concepts and learning environments.

### CROSS-REFERENCE TO RELATED APPLICATIONS

This application is a continuation of U.S. patent application Ser. No. 12/153,310, filed May 16, 2008; the content of which is incorporated herein by reference in its entirety.

### FIELD OF THE INVENTION

The present invention relates generally to methods and systems for education, and, more particularly, to methods and systems for structured teaching of mathematics and other subjects using creative movement and rhythm.

### BACKGROUND OF THE INVENTION

Educational methods currently used in most schools generally focus on instructors lecturing students on one or more topics in a passive learning environment. Students may be expected to focus on a single subject for extended periods of time and assimilate information provided by instructors through passive listening and watching. Much of the current educational curriculum may rely on rote memorization for students to learn material provided in lessons. Neither passive learning nor rote memorization are effective methods for students to learn new materials. These teaching methods only allow students to achieve a superficial understanding of new materials. These teaching methods do not allow for development of problem solving skills by students or the ability to adapt learned materials to other situations. Furthermore, these methods do not address the needs of students with multiple learning styles, such as kinesthetic/movement, musical/auditory, and intrapersonal/social learners.

Some methods of incorporating movement and rhythm into lesson plans have been used by individual instructors. These methods, however, are simplistic and informal. These methods are not structured teaching methods that can be adapted to other lessons or subjects.

Generally, needs exist for improved methods and systems that formalize the education process to assist instructors in developing lesson plans that incorporate student observation and discussion, social learning experiences, creative movement and rhythm to improve retention and comprehension of lesson materials by students.

### SUMMARY OF THE INVENTION

Embodiments of the present invention solve many of the problems and/or overcome many of the drawbacks and disadvantages of the prior art by providing methods and systems for formalized teaching that incorporate creative movement and rhythm.

Embodiments of the present invention may include educational methods including instructing one or more students to perform a first activity wherein the one or more students experience a teaching concept through movement or rhythm, instructing the one or more students to perform a second activity wherein the one or more students experience the teaching concept through movement or rhythm that is spatially or rhythmically different than the first activity, facilitating student observation and discussion regarding the teaching concept and the relationships of the teaching concept to the first activity and the second activity, assessing the one or more students based upon an ability to create original movement and rhythm that corresponds to the teaching concept, and wherein the steps may be performed in any order.

Embodiments of the present invention may also include a system for teaching fractions including one or more duration indicators arranged in a pattern, wherein each of the one or more duration indicators represents a fractional time of a whole time via a dimension of each of the one or more duration indicators, one or more vocal indicators arranged in a pattern, wherein each of the one or more vocal indicators represents a sub-pattern of fractional time of a whole, wherein the pattern of the one or more duration indicators represents a total duration of time and the pattern of the one or more vocal indicators represents the total duration of time, and wherein the system teaches fractional relationships by simultaneously vocalizing in the pattern of the one or more vocal indicators and visually following along with the one or more duration indicators.

Embodiments of the present invention may also include a system for teaching number concepts including one or more unit indicators arranged in a pattern, wherein each of the one or more unit indicators represents a movement or sound to be performed in time with a steady beat, wherein the pattern of the one or more unit indicators represents a mathematical algorithm, and wherein the system teaches number concepts by simultaneously moving or vocalizing the one or more unit indicators in the pattern of the one or more unit indicators and visually following along with the one or more unit indicators.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a flow diagram showing a formalized set of steps for integrating education with creative movement and/or rhythm.

FIG. 2 shows an exemplary sequence of creative movements that may be appropriate for kindergarten age students to learn repeating patterns.

FIG. 3 shows an exemplary sequence of creative movements that may be appropriate for kindergarten through first grade age students to learn skip counting.

FIG. 4 shows an exemplary sequence of creative movements that may be appropriate for first through second grade age students to learn repeated addition.

FIG. 5 shows an exemplary sequence of creative movements that may be appropriate for third grade age students to learn multiplication.

FIG. 6 shows an exemplary sequence of creative movements that may be appropriate for third grade age students to learn division.

FIG. 7 shows an exemplary sequence of creative movements that may be appropriate for fourth grade age students to learn the commutative property of multiplication.

FIG. 8 shows an exemplary sequence of creative movements that may be appropriate for fourth grade age students to learn remainders.

FIGS. 9A-9B show an exemplary sequence of creative movements that may be appropriate for sixth grade age students to learn using parentheses.

FIG. 10 shows an exemplary sequence of creative movements that may be appropriate for fifth through sixth grade age students to learn equivalent fractions.

FIG. 11 shows an exemplary series of fractional counts with word and fraction indicators.

FIG. 12 shows an exemplary series of fractional counts with words.

FIG. 13 shows an exemplary series of fractional counts with length indicators.

FIG. 14 shows an exemplary fractional counting method with images and corresponding fractions.

FIG. 15 is a flow diagram of a system and method for teaching instructors a formalized educational method.

FIG. 16 is a schematic diagram of a kit for learning or teaching a formalized educational method.

### DETAILED DESCRIPTION OF THE PREFERRED EMBODIMENTS

Embodiments of the present invention may provide educational systems and methods that integrate musical rhythm, rhythmic movement, and/or creative movement with educational lessons. The following description focuses on the teaching of mathematics. The present invention, however, may also be applicable to other educational subjects. The use of mathematics is merely an exemplary embodiment for illustrative purposes. Furthermore, embodiments of the present invention may be generally applicable to classes of students, but the methods of the present invention may be adapted to teach individual students or smaller groups, if needed.

Embodiments of the present invention may provide a multi-step, formalized process for teaching educational methods. An instructor may develop a lesson plan for a class based upon the multi-step, formalized process prior to teaching one or more students. The instructor may know the steps associated with the present invention and may fit the subject matter for a lesson into the formalized method to increase the effectiveness of the lesson. Methods of teaching and/or learning the formalized education method are disclosed herein.

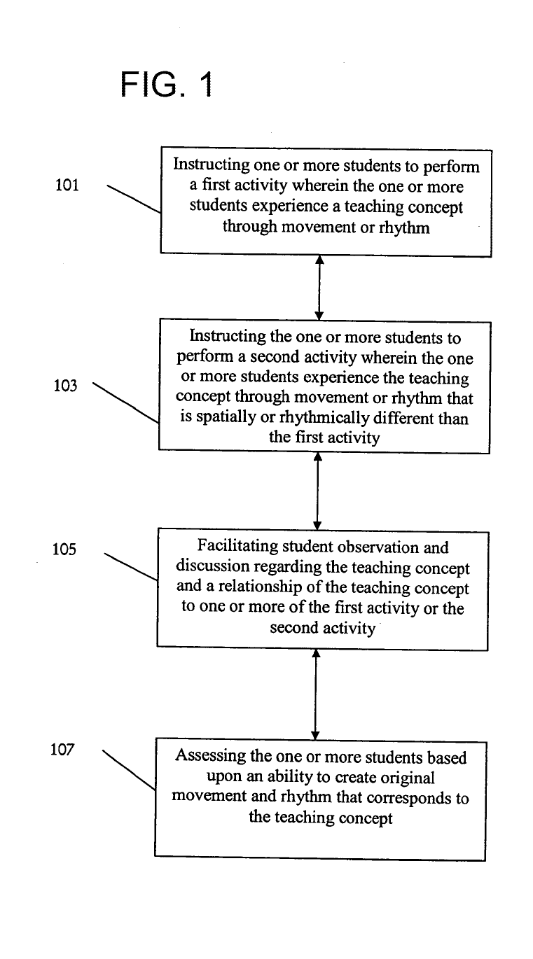

The methods and systems described herein generally contain four primary steps. The primary steps, as illustrated in FIG. 1, may be: (1) students experience a lesson through a first activity involving movement and/or rhythm 101, (2) students experience a lesson through a second activity involving movement and/or rhythm 103, (3) student observation and discussion 105, and (4) creative assessment 107.

Additional steps may be added to embodiments of the present invention or steps may be removed from embodiments of the present invention without departing from the scope of the present invention. The steps of the present invention may be broken into sub-steps and/or practiced in various orders depending on a particular application. For example, the student observation and discussion 105 may be performed prior to experiencing the lesson through a first activity 101. The student observation and discussion 105 may provide the students with a background for the lesson prior to performing the activity. Alternatively, an additional step may be added prior to the experiencing the lesson through a first activity 101 to introduce a concept, and the student observation and discussion may be performed later. Various step orders are contemplated.

The first activity and second activities may be any movement and/or rhythm. For example, the first activity and the second activity may be creating patterns with movement or sound, performing motions, moving with one or more props, performing vocalizations or other sounds, playing instruments, forming body shapes, etc. To perform the first activity and/or the second activity, an instructor may divide the students into groups or the students may divide themselves into groups. The instructor may provide direction to the students regarding when to perform the first activity and/or the second activity.

The first activity and the second activity may relate to a lesson concept. For example, patterns may be created by performing a set of motions to teach a specific concept, such as counting by groupings. By performing the first activity and the second activity, the students may experience the lesson physically and not merely mentally. The physical experience may allow for deeper comprehension and understanding of the lesson.

The student observation and discussion step may be facilitated by an instructor. The instructor may provide visual indications of a lesson concept. For example, the instructor may provide drawings and/or algorithms representing a lesson concept.

The instructor may begin discussion of the lesson concept by asking questions of the students or asking students to make observations on the lesson concept. The instructor may then prompt responses from students or take volunteer comments from students. The discussion may focus on the lesson concept taught by the first activity and the second activity. Students may share observations and comments on how the first activity and the second activity relate to the lesson concept. Students may build upon previous comments by other students. The instructor may repeatedly prompt the students with questions or observations to facilitate the discussion. Through the step of student observation and discussion, the students may develop a deeper understanding of the lesson concept.

The creative assessment step may provide the one or more students with the ability to apply the lesson concept. The instructor may facilitate the activities of the one or more students to develop unique movements and/or rhythms to show the students' comprehension of the lesson concept. The creative activity may be creating patterns with movement or sound, performing motions, moving with one or more props, performing vocalizations or other sounds, playing instruments, forming body shapes, etc. The one or more students may develop the creative movement. The one or more students may then perform the unique movement and/or rhythms developed by the one or more students for the instructor and/or other students.

After the performances, other students may be allowed to comment and ask questions regarding the unique movements and/or rhythms of the performing student. The comments and questions may be directed to how the unique movements and/or rhythms relate to the lesson concept and how the unique movements and/or rhythms represent the lesson concept. The instructor may facilitate the comments and questions.

The creative assessment step may also provide the instructor with the ability to gauge comprehension of the lesson plan by the class as a whole and by individual students. The instructor may provide feedback to the class as a whole and/or individual students regarding how well the lesson concept was understood. Additionally, the instructor may record observations on comprehension of the lesson plan by the class as a whole and/or by individual students.

Embodiments of the present invention may be particularly applicable to elementary education, such as kindergarten through sixth grade, but may be extended to higher education, adult education, etc.

The methods of the present invention may be used to teach various concepts. In the following description, the subjects of (1) number concepts, (2) spatial/geometric concepts and (3) fractions are generally described as examples of the present invention. Each subject may have many individual lessons. The present invention is not limited to these subjects or mathematics in general, and the following is for illustrative purposes only.

The methods of the present invention have many benefits over other teaching methods that do not use rhythmic or creative movement. The present invention may be used as a primary teaching means and is not merely a supplemental teaching method. By reducing rote memorization, the present invention may provide a deeper comprehension of the subject matter. The present invention may have further benefits by teaching to multiple learning styles of students, including kinesthetic/bodily, musical/auditory, visual/spatial, and intrapersonal/social learners. The methods of the present invention may also allow for differentiated group instruction by providing students with a spectrum of skills to develop understanding in a variety of ways and at a variety of levels. The methods of the present invention may inspire student creativity, excitement, and enthusiasm, while challenging students to higher-order thinking skills.

An embodiment of the present invention may be educational systems and methods that integrate rhythm and rhythmic movement with number concepts. This embodiment may be a formalized, systematic method for teaching the scope and sequence of key mathematical number concepts by connecting patterns in rhythmic movement to patterns in mathematics. This embodiment may include a series of lesson structures for teaching various math concepts to students of various ages and ability levels. For number concepts, each lesson structure may generally follow a four step sequence that leads students through a guided learning process.

A system for teaching number concepts may include one or more unit indicators arranged in a pattern, wherein each of the one or more unit indicators represents a movement and sound to performed at a steady beat, thus creating a rhythmic movement phrase. The organization of these unit indicators may represent mathematical organizations such as sequences and groupings. The system may teach mathematical algorithms by simultaneously moving and sounding patterns and groupings that represent mathematical concepts.

Number Concepts: Step I—Experience the Math Concept Through Rhythmic Movement

Initially, an instructor may lay out indicator devices in specific patterns that represent the mathematic number concept being taught. Indicator devices may preferably be cards, but could be any objects, such as blocks, various shaped toys, etc. The indicator devices may be color coded to facilitate recognition by students. Each indicator device may have a picture that indicates a specific rhythmic movement to be performed by a class. The instructor may conduct the activity of the class of students by tapping, pointing at, or otherwise indicating a particular indicator device at a steady beat while the class performs the specific rhythmic pattern indicated on the indicator device when instructed by the teacher. This may allow the class to experience the mathematic number concept through rhythmic movement.

Number Concepts: Step II—Experience the Math Concept Spatially

In addition to experiencing the mathematic number concept through rhythmic movement, the methods of the present invention may provide for experiencing the mathematical number concept through spatial activity. The instructor may divide the class into sections or groups, and each section or group may be assigned a specific indicator device with a correlating rhythmic movement. Therefore, when the teacher conducts the class, each section or group may be playing only part of the pattern corresponding to the assigned indicator device. This may be critical for helping the class see, hear, and feel how the parts work together to create a whole in the mathematical number concept.

Number Concepts: Step III—Student Observation and Discussion

After experiencing the mathematical number concept through rhythmic movement and/or spatial activity, the instructor may facilitate student observation and discussion related to the mathematical number concept. The instructor may draw a series of pictures and/or algorithms on a board or use preexisting pictures and/or algorithms, connected to the mathematical number concept taught in Steps I and II. The series mathematical number concepts, however, may not be explicitly identified or labeled. As a group, the class may share what they notice about the pictures and/or algorithms. Individual students may build upon observations made by other students in the class. Through guided observation and discussion, individual students in the class may begin to connect the pictures and/or algorithms to the mathematical number concept, creating their own mathematical definitions and own meanings. This may result in deeper understanding of the mathematical concepts than would be developed through traditional teaching methods.

Number Concepts: Step IV—Creative Assessment

After the class has had time to observe and discuss, the instructor may again break the class into smaller groups. For example, students may work with a partner to create a unique rhythmic movement phrase that represents the mathematical number concept taught in Steps I-III. The students may then perform the unique rhythmic movement for the instructor and/or the rest of the class. Individual students may then be assessed by the instructor on the creativity of movement choices, timing and ensemble work, and knowledge of the mathematical number concept represented by the rhythmic movement. After performing the rhythmic movement, the instructor may facilitate a series of questions between students to determine the algorithm represented.

This four step version of the method of the present invention may form a basis of a series of lessons that show how patterns underlie the scope and sequence of number concepts in mathematics. Below is a series of examples illustrating various number concepts and relationships to rhythmic movement. This mathematical scope and sequence may be correlated with increasing complexity in rhythmic movement.

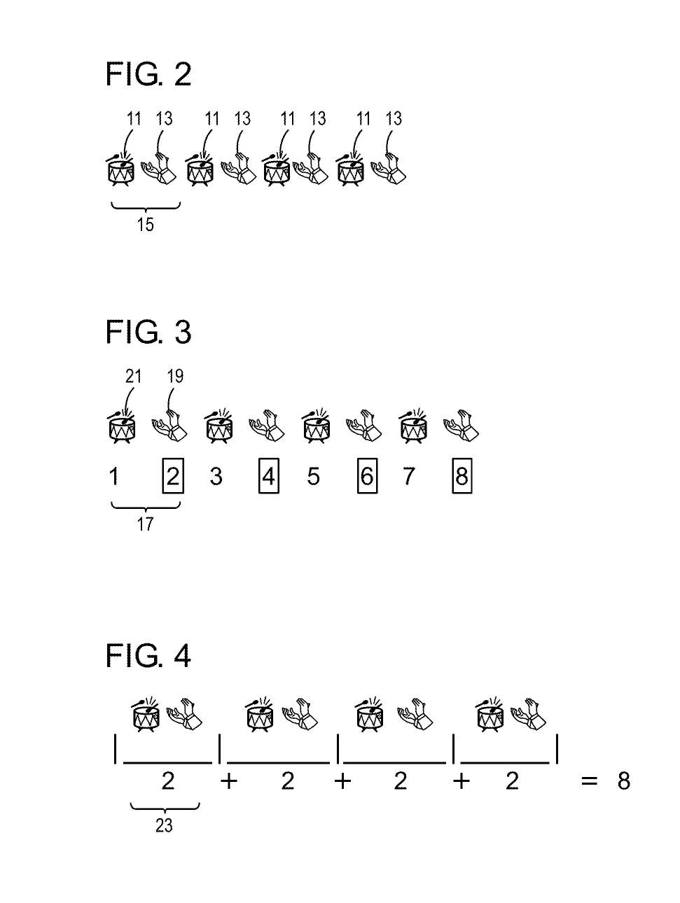

FIG. 2 shows an exemplary sequence of creative movements that may be appropriate for kindergarten age students to learn repeating patterns. As described above, the pattern may be indicated on indicating devices. Each indicating device may include a representation of the creative movement, such as, but not limited to, clapping, drumming, snapping, playing a musical instrument, jumping, stomping, resting, etc. The example of FIG. 2 may be experienced as a repeating pattern of: drum 11, clap 13, drum 11, clap 13, drum 11, clap 13, drum 11, clap 13. The pattern unit may be drum/clap 15 and the pattern may be repeated four times in this particular example.

FIG. 3 shows an exemplary sequence of creative movements that may be appropriate for kindergarten through first grade age students to learn skip counting. The repeating pattern 17 of FIG. 3 may be felt as groups of two rhythmic movements. Students may count the indicator devices as the students move, emphasizing a clap second rhythmic movement 19 that may mark the end of each pattern unit 17. A first rhythmic movement 21 may have less emphasis. Students may physically experience the concept that skip counting by two means counting groups of two.

FIG. 4 shows an exemplary sequence of creative movements that may be appropriate for first through second grade age students to learn repeated addition. Students may physically experience the repeating pattern 23 as repeating groups of two. Students may physically experience the relationship between repeating patterns and repeated addition.

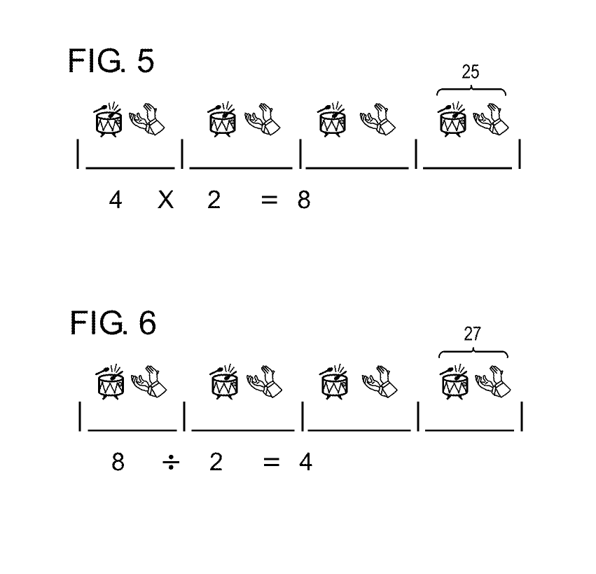

FIG. 5 shows an exemplary sequence of creative movements that may be appropriate for third grade age students to learn multiplication. Students may feel the repeating pattern as four equal groups 25 of two. Four groups of two yield eight. This may be represented as 4×2=8.

FIG. 6 shows an exemplary sequence of creative movements that may be appropriate for third grade age students to learn division. Students may feel the repeating pattern as eight in all, divided into 4 equal groups 27 with two in each group. This may be represented as 8÷2=4.

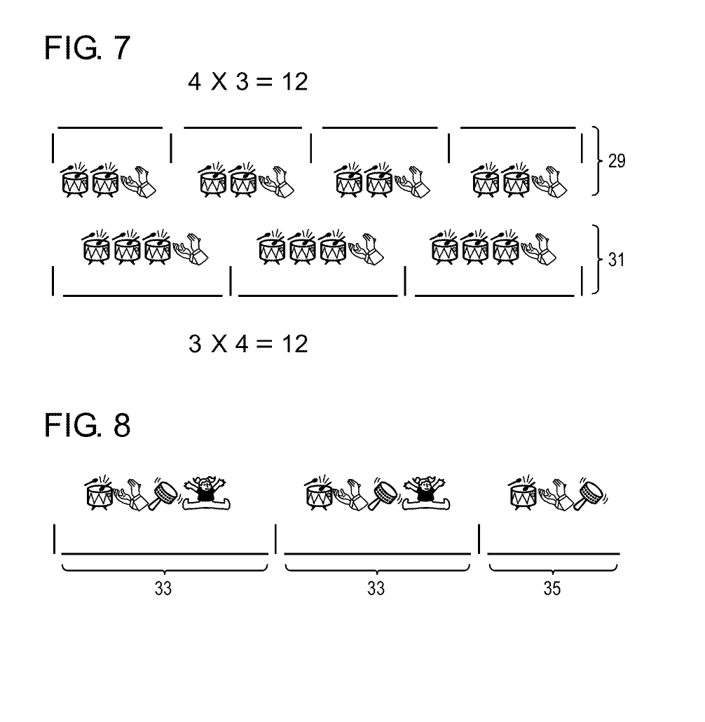

FIG. 7 shows an exemplary sequence of creative movements that may be appropriate for fourth grade age students to learn the commutative property of multiplication. Students may divide into two or more groups and play two or more rhythmic phrases at the same time. One group may play four groups of three 29 while the other group may play three groups of four 31. Students may experience the relationship between polymetrics in music and the commutative property in mathematics.

FIG. 8 shows an exemplary sequence of creative movements that may be appropriate for fourth grade age students to learn remainders. Students may physically experience this repeating pattern as two complete groups of four 33, plus an incomplete group of three 35, which may create eleven moves in all. Mathematically, this may be written as: 2×4+3=11 or 11÷4=2 Remainder 3.

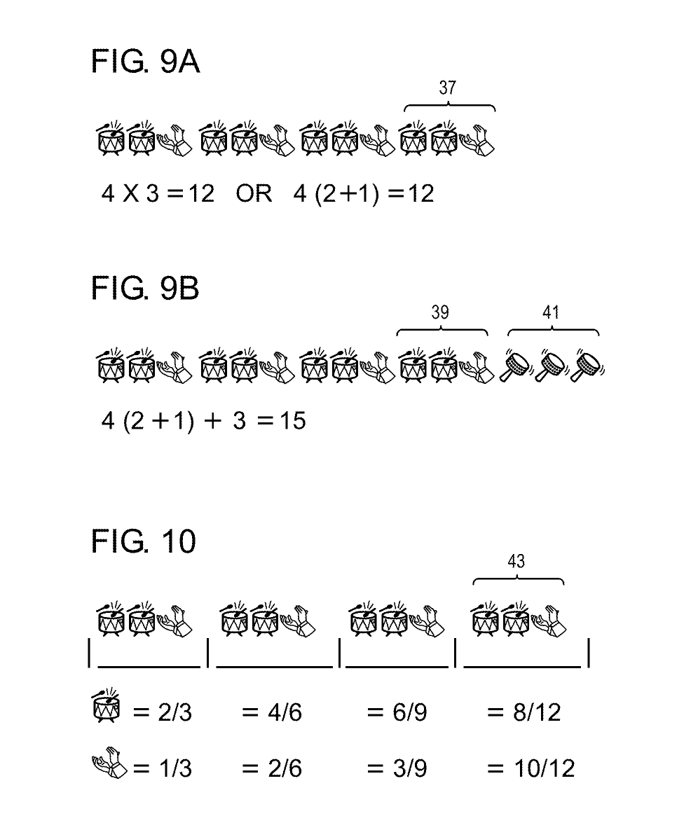

FIGS. 9A-9B show an exemplary sequence of creative movements that may be appropriate for sixth grade age students to learn using parentheses. This repeating pattern may be felt as four complete groups of three 37. When the pattern is played spatially, with one group playing the drums and a different group playing the claps, students may experience the parts (2+1) that work together to create the whole, as shown in FIG. 9A. In FIG. 9B, parentheses may show the parts of the rhythmic phrase that are grouped together. They serve the same function in mathematics. In this example, a group of two drums and one clap 39 is combined before multiplication or addition of a group of three alternate movements 41.

FIG. 10 shows an exemplary sequence of creative movements that may be appropriate for fifth through sixth grade age students to learn equivalent fractions. An instructor may divide the class into two or more groups, with one group playing drums and another group playing claps. The students may feel the parts combine to make each pattern unit. As the pattern unit 43 is repeated, equivalent fractions are generated.

Another embodiment of the present invention may be an educational method that integrates creative movement with elementary spatial and/or geometric concepts. This embodiment may be a formalized, systematic method for teaching the scope and sequence of key spatial and geometric concepts through connecting the concepts of line, angle, shape, and space in creative movement to parallel concepts in geometry.

The method of the present invention may include a series of lesson structures. Each lesson structure may follow a specific four step sequence that takes students through a guided learning process. The present invention may allow students to have a consistent process for making the transfer from geometric concepts to creative movement, and for training instructors to implement this work. Instructors may be able to pick up the new teaching strategy more easily because there is a formalized process or method.

For integrating creative movement with elementary spatial and/or geometric concepts, each lesson structure may generally follow a four step sequence that leads students through a guided learning process.

Spatial and/or Geometric: Step I—Student Observation and Discussion

In contrast to the previous exemplary embodiment, this embodiment may include student and observation prior to engaging a class in creative movement. An instructor may draw a series of pictures and/or algorithms on a board or utilize preexisting pictures and/or algorithms. The series of pictures and/or algorithms may show one or more target spatial and/or geometric concept, but, preferably, without identifying or labeling the one or more spatial and/or geometric concepts. As a group, students may share what they notice about the pictures and/or algorithms. Students may build upon observations from other students. Through guided observation and discussion from the instructor, students may connect the pictures and/or algorithms to the geometric concepts, thus, creating their own mathematical definitions and own meanings.

Spatial and/or Geometric: Step II—Solo Movement with a Dance Band

Each student may move independently, using a stretch band that can be manipulated to make lines and shapes, and to rotate these lines and shapes in space. A key factor of using creative movement to teach geometry may be the ability to move off the 2-dimensional space of a written page and into a 3-dimensional space of creative movement. This may allow students to physically execute slides, flips, rotations, and other geometric transformations that cannot be easily shown on paper. For example, a student may work with a dance band to create a square by holding a length of the dance band against the floor with feet spread apart to create to corners of the square. The student may then raise hands above the spread feet to create the remaining two corners of the square.

Spatial and/or Geometric: Step III—Partner Movement with a Dance Band

Students may then practice the shapes and geometric transformations practiced in Step II, but with the increased complexity of working with a partner. When working with a partner, students may experience lines and shapes differently, shifting their focus from manipulating the whole to manipulating the parts that work together to create the whole. For example, a first student may use two hands to create two adjacent corners of a square. A second student may grasp the dance band with two hands to create the remaining two corners of the square.

Spatial and/or Geometric: Step IV—Creative Assessment

Students may then work with a partner without using the dance bands as props. Student may use body line and body shape to create a unique creative movement shape or phrase that represents the geometric concept taught. Students may be assessed on the creativity of their movement choices, their timing and ensemble work, and their knowledge of the geometric concept that their movement phrase represents. After performing their movement phrases, students may ask each other what geometric concepts their movement was intended to represent.

This embodiment of the present invention may form a basis of a series of lessons that show how lines and angles underlie the scope and sequence of spatial and geometric concepts in mathematics. This mathematical scope and sequence may be correlated with increasing complexity in creative movement. Subjects that may be taught with the present invention may include, but are not limited to, mirror reflection symmetry; bi-lateral symmetry; line: segment, ray endpoint; line orientation: vertical, horizontal, and diagonal; lines: parallel, intersecting, perpendicular; angle: vertex, acute, right, obtuse; angle relationships: adjacent, opposite; angle relationships: supplementary, complementary; triangle: flips, rotations, side/angle relationships; square and rectangle: flips and rotations; quadrilaterals: parallelograms, trapezoids, side/angle relationships; translation/slide symmetry; combining shapes/composite shapes; and 3-dimensional solids: pyramids and prisms with flips and rotations.

Another embodiment of the present invention may be an educational method that integrates rhythm and vocal improvisation with elementary fraction (part-to-whole relationship) concepts. This embodiment may be a formalized, systematic method for teaching the scope and sequence of key fraction concepts by connecting part-to-whole relationships in musical rhythm to parallel concepts in mathematics.

This embodiment of the present invention may include a series of lesson structures. Each lesson structure may follow a specific sequence that takes students through a guided learning process.

Music Integration: Step I—Experience the Math Concept Through Rhythm and Sound

Students may create a set of color-coded fraction indicators. Alternatively, the fraction indicators may be pre-fabricated by the instructor or obtained as a kit. The fraction indicators are preferably strips that may divide a whole into equal parts in different ways—two halves, four fourths, eight eights, etc. Other fraction indicators are possible as long as a main object or drawing is divided into various fractions pieces. On the front of each strip may be a numerical fraction that represents its relationship to the whole—½, ¼, ⅛, etc. On the back of each strip may be a word or vocal rhythm that is associated with that fraction. More than one word or vocal rhythm may be associated with each fraction. For example, “whooooosh” may correspond to a whole, “craaa” for ½, “creee” for ½, “tic” for ¼, “toc” for ¼, etc. The instructor may conduct the vocalization of the class by counting off a steady beat that cues one or more students to perform an indicated rhythms created by the fractional patterns. This may allow students to experience fraction concepts through rhythm and sound.

Music Interpretation: Step II—Experience the Math Concept Spatially

The instructor may divide the class into sections, and each section may be assigned a specific fractional combination that adds up to a whole. For example, one group may play four fourths while the other group plays one half and two fourths. Students may hear and feel how the rhythmic and fractional concepts interact. Students may connect polyrhythm in music to equivalency in fractions. This may be critical for helping students see, hear, and feel how the parts work together to create the whole in mathematics.

Music Interpretation Step III—Student Observation and Discussion

The instructor may draw a series of pictures and/or algorithms on the board or utilize preexisting pictures and/or algorithms. The pictures and/or algorithms may be connected to the math concept taught in Steps I and II, but without the pictures and/or algorithms being specifically identified or labeled. As a group, the students share what they notice about the pictures and/or algorithms. Students may build upon observations of other students. Through guided observation and discussion, the students may connect the pictures and/or algorithms to the math concepts, creating their own mathematical definitions and meanings.

Music Interpretation: Step IV—Creative Assessment

Students may then work with a partner to create a unique rhythmic phrase that represents the fractional concept taught. Students may be assessed on the complexity of their sound and rhythmic choices, timing and ensemble work, and knowledge of the mathematical algorithm that the rhythmic phrase represents. After performing the rhythmic phrases, the students may ask each other a series of questions regarding what lead to determining their algorithm.

This embodiment of the present invention may form a basis of a series of lessons that show how rhythm relates to fraction concepts in mathematics. This mathematical scope and sequence may be correlated with increasing complexity in the performance of musical rhythm. Exemplary subjects may include, but is not limited to, regular fractions, improper fractions, mixed fractions, improvisation with fractions, lines, and musical notation.

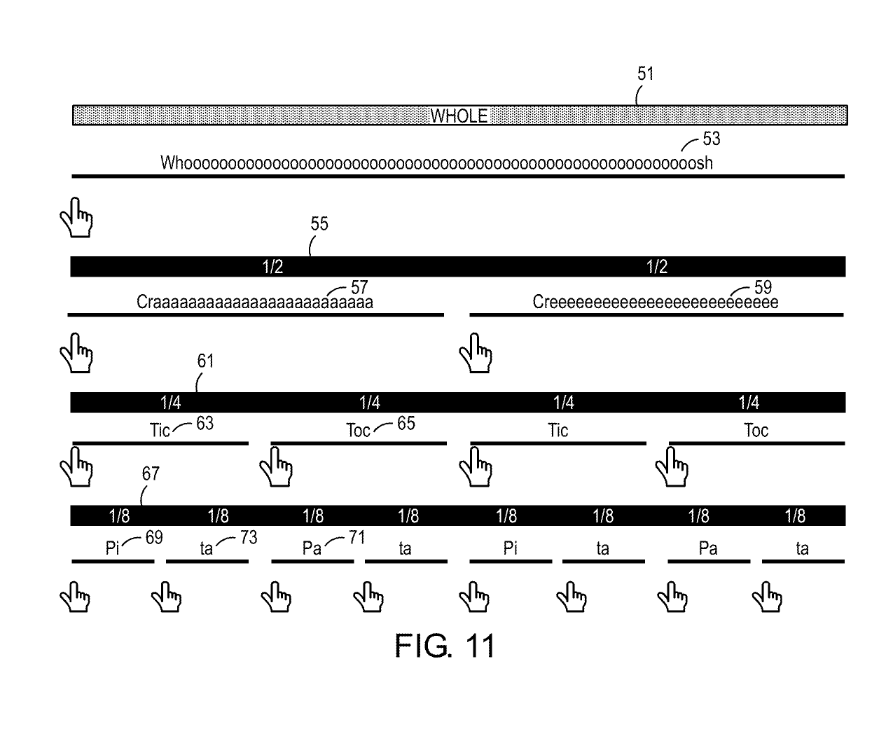

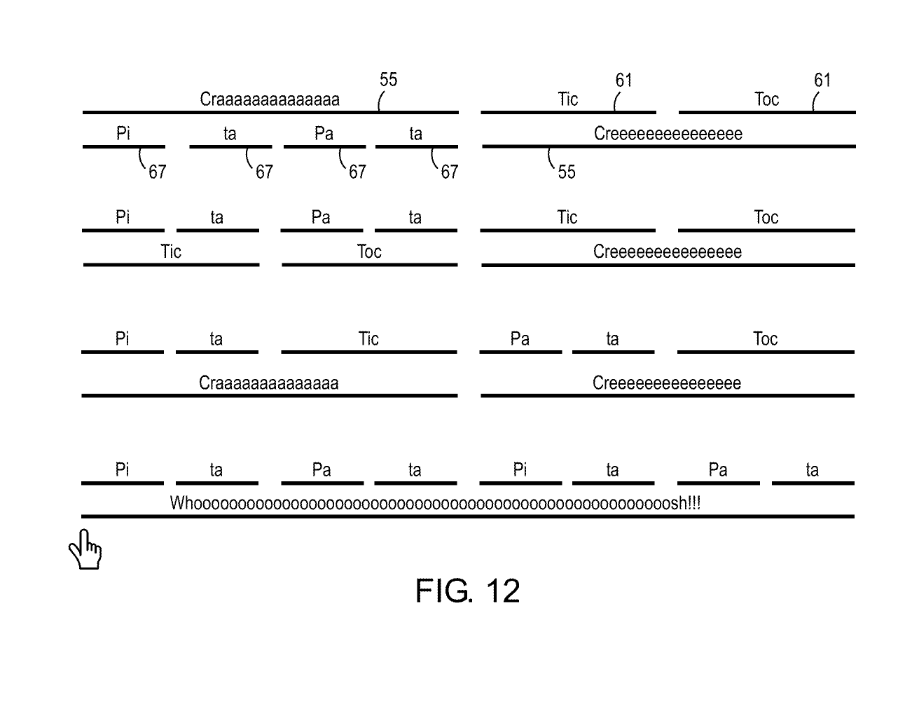

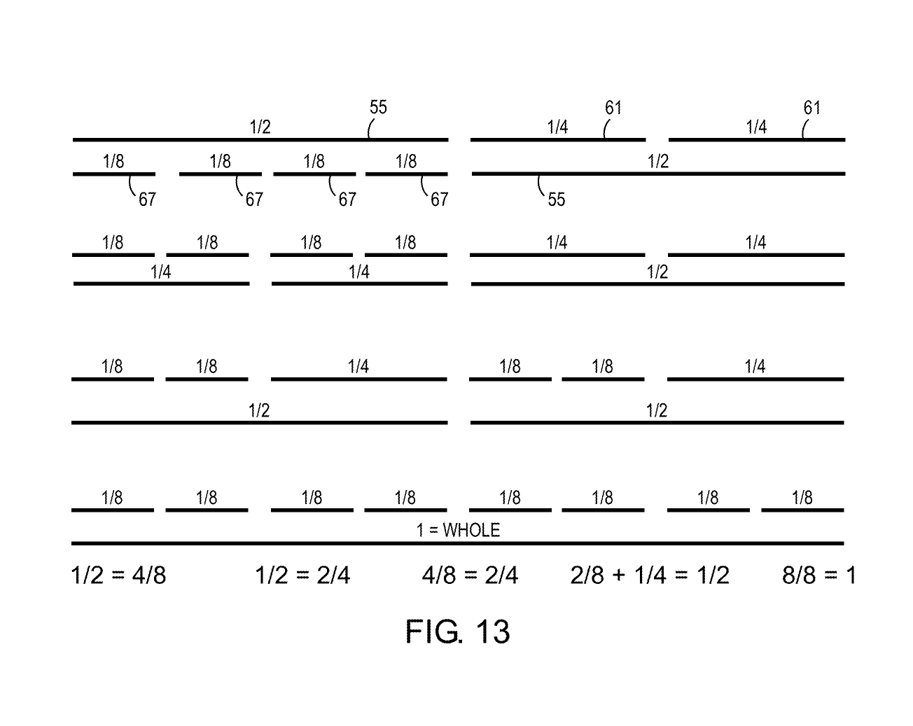

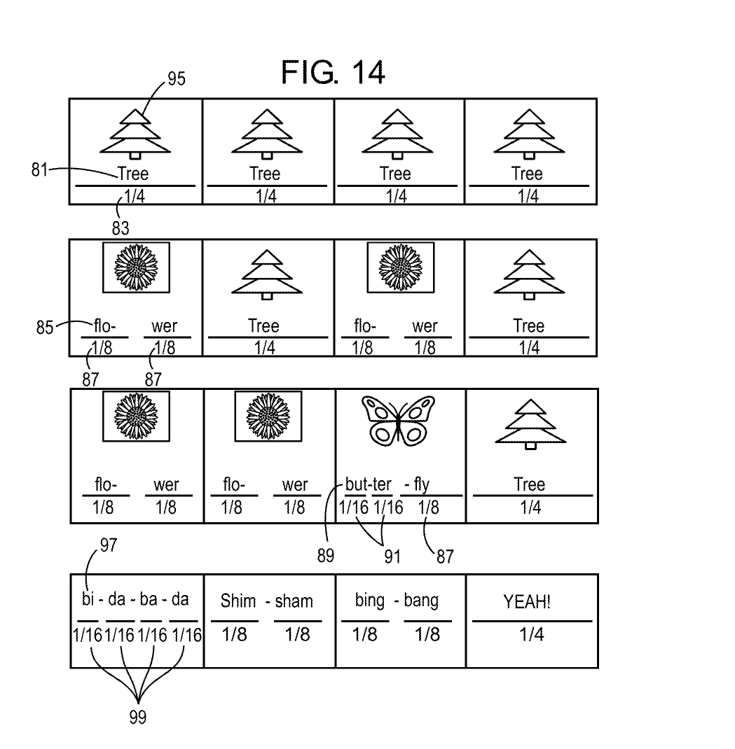

FIGS. 11-14 illustrate a system of horizontal lines of varying lengths representing fractional and proportional relationships involved in the division of time. The length of a line may represent the duration of time of a sound. When vocal sounds of rhythms are associated with each different length, the system may represent rhythmic notation. See, for example, FIGS. 11-13. FIG. 11 shows an exemplary series of fractional counts with word and fraction indicators. A whole count 51 may correspond to a sound such as “whooooooooooooosh” 53; a half count 55 may correspond to sounds such as “craaaaaaaaaa” 57 and/or “creeeeeeeee” 59; a quarter count 61 may correspond to sounds such as “tic” 63 and/or “toc” 65; and an eight count 67 may correspond to sounds such as “pi” 69, “pa” 71 and/or “ta” 73. FIG. 12 shows an exemplary series of fractional counts with sounds to create a rhythmic composition. FIG. 13 shows the exemplary series of fractional counts from FIG. 12 with fractions substituted for the sounds.

The system of the present invention may be further extended to incorporate rhythms created when words are syllabicated. This may help students to improvise freely using real and invented words, while maintaining underlying fractional and rhythmic relationships. The system may further connect rhythms in music to rhythms in language patterns to fractions in math. See, for example, FIG. 14. FIG. 14 shows an exemplary fractional counting method with images and corresponding fractions. For example, the word “tree” 81 may be used to represent a quarter count 83, the word “flower” 85 may be used to represent two eighth counts 87, and the word “butterfly” 89 may be used to represent two sixteenth counts 91 followed by an eighth count 93. Images 95 may be associated with words. Furthermore, words may be created to correspond to desired count lengths and patterns, such as “bi-da-ba-da” 97 to represent four sixteenth counts 99.

Embodiments of the present invention may also include methods and systems for teaching instructors about the formalized educational methods.

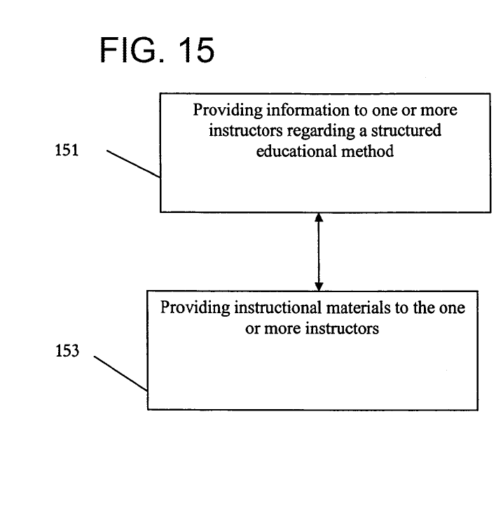

FIG. 15 is a flow diagram of a system and method for teaching instructors a formalized educational method. The instructors may learn the multi-step, formalized process by receiving information regarding the standardized educational method via classes, lectures, conferences, books, articles, pamphlets, workbooks, video, audio, Internet-based resources, and any other method 151. To learn the formalized educational method, the instructors may be provided with instructional materials 153. The instructional materials may be kept by the instructors for reference. The instructional materials may include books, pamphlets, articles, video, audio, Internet-based resources, etc. Once the instructors have mastered the multi-step, formalized process, the instructors may adapt the multi-step, formalized process to individual lessons. The standardized educational method may be applied to a particular subject of interest for the instructors.

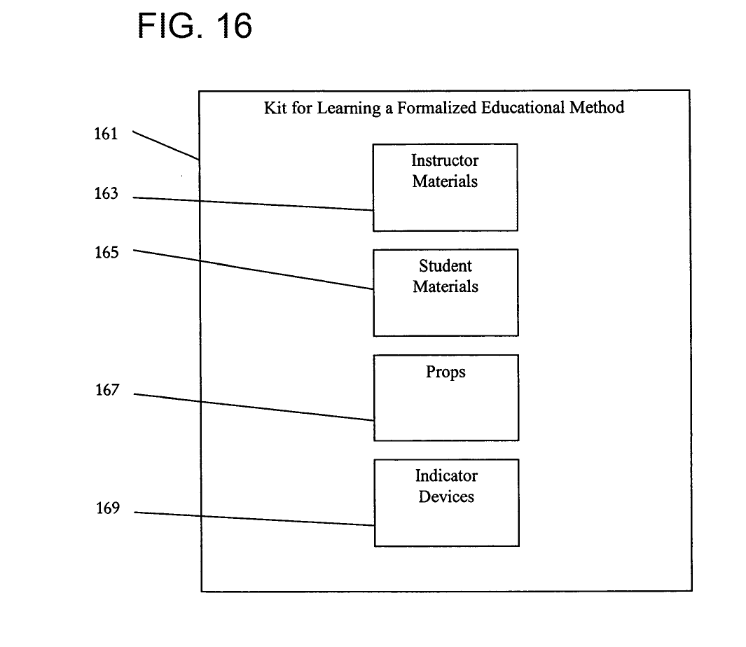

FIG. 16 is a schematic diagram of a kit 161 for learning or teaching a formalized educational method. The kit 161 may be distributed to instructors learning or practicing the standardized educational method of the present invention. The kit 161 may have various components including instructional materials for the instructor 163. The instructional materials 163 may include books, pamphlets, articles, video, audio, Internet-based resources, etc. Additional materials in the kit 161 may be instructional materials for students 165, props to facilitate the first activity, second activity and/or creative activity 167, and/or indicator device to facilitate the first activity, second activity and/or creative activity 169. Instructional materials for students 165 may include workbooks, handouts, etc. Props 167 may include musical instruments, dance bands, ropes, etc. Indicator devices 169 may include cards, blocks, etc. The kit 161 may be distributed in combination with courses instructing teachers in the standardized educational method or may be sold separately.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A system for teaching number concepts comprising:
one or more unit indicators arranged in a pattern,
wherein the one or more unit indicators represent movements or musical rhythms or are pictures of activities to be performed or words related to activities to be performed,
wherein each of the one or more unit indicators are performed in time with a steady beat,
wherein the pattern of the one or more unit indicators represents a mathematical algorithm, and
wherein the system teaches number concepts by simultaneously performing the one or more unit indicators in the pattern of the one or more unit indicators and visually following along with the one or more unit indicators.

2. The system of claim 1, further comprising visual notations related to the one or more unit indicators for correlating the pattern of the one or more unit indicators with the number concepts.

3. The system of claim 1, wherein the one or more unit indicators are used as a first activity and a second activity in a method comprising:
instructing one or more students to perform a first activity wherein the one or more students experience the number concepts through movement or musical rhythm,
instructing the one or more students to perform a second activity wherein the one or more students experience the number concepts through movement or musical rhythm that is spatially or rhythmically different than the first activity,
facilitating student observation and discussion regarding the number concepts and a relationship of the number concepts to one or more of the first activity or the second activity,
assessing the one or more students based upon an ability to create original movement and musical rhythm that corresponds to the number concepts, and
wherein the steps may be performed in any order.

4. The system of claim 3, wherein the first activity or second activity is selected from the group consisting of rhythmic movement, spatial movement, solo movement with a prop, cooperative movement between two or more students with a prop, vocalization, creating sounds, forming shapes, and combinations thereof.

5. The system of claim 3, wherein the first activity or second activity creates the pattern.

6. The system of claim 3, wherein the facilitating student observation and discussion comprises prompting the one or more students with questions or comments.

7. The system of claim 3, wherein the facilitating student observation and discussion comprises providing visual indications of the teaching concept.

8. The system of claim 3, wherein the creative activity is selected from the group consisting of rhythmic movement, spatial movement, solo movement with a prop, cooperative movement between two or more students with a prop, vocalization, creating sounds, forming body shapes, and combinations thereof.

9. The system of claim 3, wherein the creative activity is developed and performed by the one or more students.

10. The system of claim 3, wherein the assessing is based upon choice of the creative activity by the one or more students, cooperation of the one or more students with other students during the creative activity, knowledge of the teaching concept, and integration of the teaching concept with the creative activity.

11. The system of claim 3, wherein the assessing further comprises facilitating discussion between the one or more students regarding the creative activity.

12. The system of claim 1, wherein the one or more unit indicators are cards.

13. The system of claim 1, wherein the one or more unit indicators are blocks.

14. The system of claim 1, wherein the one or more unit indicators are toys.

15. The system of claim 1, wherein the one or more unit indicators may be divided into groups for performance by different groups of students.

16. The system of claim 1, wherein the performing the one or more unit indicators is via rhythmic movement.

17. A method of teaching number concepts, the method comprising:
arranging one or more unit indicators in a pattern, and
simultaneously performing the one or more unit indicators in the pattern of the one or more unit indicators and visually following along with the one or more unit indicators,
wherein the one or more unit indicators represent movements or musical rhythms or are pictures of activities to be performed or words related to activities to be performed,
wherein each of the one or more unit indicators are performed in time with a steady beat,
wherein the pattern of the one or more unit indicators represents a mathematical algorithm.

18. The method of claim 17, further comprising:
instructing one or more students to perform a first activity wherein the one or more students experience the number concepts through movement or musical rhythm,
instructing the one or more students to perform a second activity wherein the one or more students experience the number concepts through movement or musical rhythm that is spatially or rhythmically different than the first activity,
facilitating student observation and discussion regarding the number concepts and a relationship of the number concepts to one or more of the first activity or the second activity,
assessing the one or more students based upon an ability to create original movement and musical rhythm that corresponds to the number concepts, and
wherein the steps may be performed in any order.

19. The method of claim 17, wherein the one or more unit indicators are cards.

20. The method of claim 17, wherein the performing the one or more unit indicators is via rhythmic movement.
